(19) United States
(12) Patent Application Publication
(10) Pub. No.: US 2008/0240081 A1
(43) Pub. Date: Oct. 2, 2008

(54) Method, system and apparatus for providing rules-based restriction of incoming calls

(75) Inventor: Manoj Sindhwani, Oak Hill, VA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/730,218

(22) Filed: Mar. 30, 2007

(51) Int. Cl. H04J 11/00

(52) U.S. Cl. 370/352

(57) ABSTRACT

In a method, system and apparatus for providing rules-based restriction of incoming calls, a network entity such as a call manager receives a call request from a caller to setup a call to the client. The call manager includes a database including a client profile for the client, the client profile including identification data for the client and one or more client-defined conditions for accepting calls. The call manager also includes a processor coupled to the database that is configured to: query the database to obtain the client profile for the client in response to the call request received from the caller; determine if the call request from the caller satisfies the one or more client-defined conditions; and reject the call request if the call request is determined not to satisfy the one or more client-defined conditions.

### TECHNICAL FIELD

The technical field relates generally to communication networks and, more particularly, to methods, systems and apparatus for providing a rules-based restriction of incoming calls received via the communication network.

### BACKGROUND

Generally, a service provider's communication network can provide communication services such as voice or data to clients. The communication network can include a call manager for participating in signaling and device control flow, and for originating, terminating or forwarding call setup related messages from a caller to a called party, which will be referred to hereinafter as a client. For example, a packet-based network such as a Voice over Internet Protocol (VoIP) network can include a Session Initiation Protocol (SIP) server or an H.323 gatekeeper serving as the call manager.

The call manager can also include service logic for supplementary services such as, for example, caller identification, call waiting, call forwarding, call transfer, or interaction with application servers to support services not directly hosted at the call manager.

A client may wish to restrict the time frame and/or the entities from which calls or messages are received via the communication network. Further, the client may wish to dynamically change these restrictions in accordance with day to day demands.

Therefore, what is needed is an entity at the communication network such as the call manager that includes the capability to provide further supplementary services to a client. It would be advantageous if such an entity was capable of being configured by a client through an interactive device.

### SUMMARY

Accordingly, a network-based call manager according to one or more embodiments provides rules-based restriction of incoming calls. The call manager includes a database having client profiles for clients including identification data and one or more client-defined conditions for accepting calls. The call manager also includes a processor coupled to the database and configured to query the database to obtain the client profile for the client in response to a call request for a client received from a caller, and to determine if the call request from the caller satisfies the one or more client-defined conditions. The processor is also configured to reject the call request if it does not satisfy the one or more client-defined conditions.

The processor can further be configured to establish one of: an Voice over Internet Protocol (VoIP) network connection between the client and the caller; a Public Switched Telephone Network (PSTN) connection between the client and the caller; and a cellular connection between the client and the caller, if the call request is determined to satisfy the one or more client-defined conditions. Accordingly, the processor can be configured in accordance with one of a class 4 switch, a class 5 switch, a mobile switching center switch, a Session Initiation Protocol (SIP) proxy, an H.323 gatekeeper, a Media Gateway Control Protocol (MGCP) call agent, a Megaco media gateway controller, a mobile Home Location Register (HLR), and a mobile Visitor Location Register (VLR).

The processor can be configured by installing a computer-readable medium including executable instructions onto the processor.

A method of restricting incoming calls for a client receiving access to a network from a network entity according to one or more embodiments includes: receiving a call request to a client, the call request originated by a caller and including caller specific identification information; querying a database coupled to the network entity to determine if the call request complies with client preferences defined in a client profile stored in the database; and rejecting the call request if the call request is determined to not comply with the client preferences.

The method can also include determining if the caller specific identification information is among one or more permissible caller identifications specified in the client profile, and/or determining if the call request was sent during a permissible time period.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present invention.

FIG. 1 is a diagram illustrating a simplified and representative environment in which a system, method and/or apparatus for providing rules-based restriction of incoming calls can be implemented;

FIGS. 2A-2B are block diagrams of an exemplary call manager;

FIG. 2C is a block diagram of an exemplary call processing engine;

FIG. 3 is a flow diagram illustrating an exemplary procedure for providing rules-based restriction of an incoming call from a caller for a client;

FIGS. 4A-4B are diagrams illustrating exemplary operations of the call manager;

FIG. 5 is a flow diagram illustrating an exemplary procedure for providing exemplary restrictions; and

FIGS. 6A-6B are diagrams illustrating exemplary operations of the call manager.

### DETAILED DESCRIPTION

In overview, the present disclosure concerns communication networks provided by service providers, and entities in the communication networks, such as call managers and clients that access communication services from the communication networks. More particularly, various inventive concepts and principles are embodied in systems, apparatus, and methods therein for providing rules-based restriction of incoming calls to clients.

The instant disclosure is provided to further explain in an enabling fashion the best modes of performing one or more embodiments of the present invention. The use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in computer instructions (software) or integrated circuits (ICs), and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

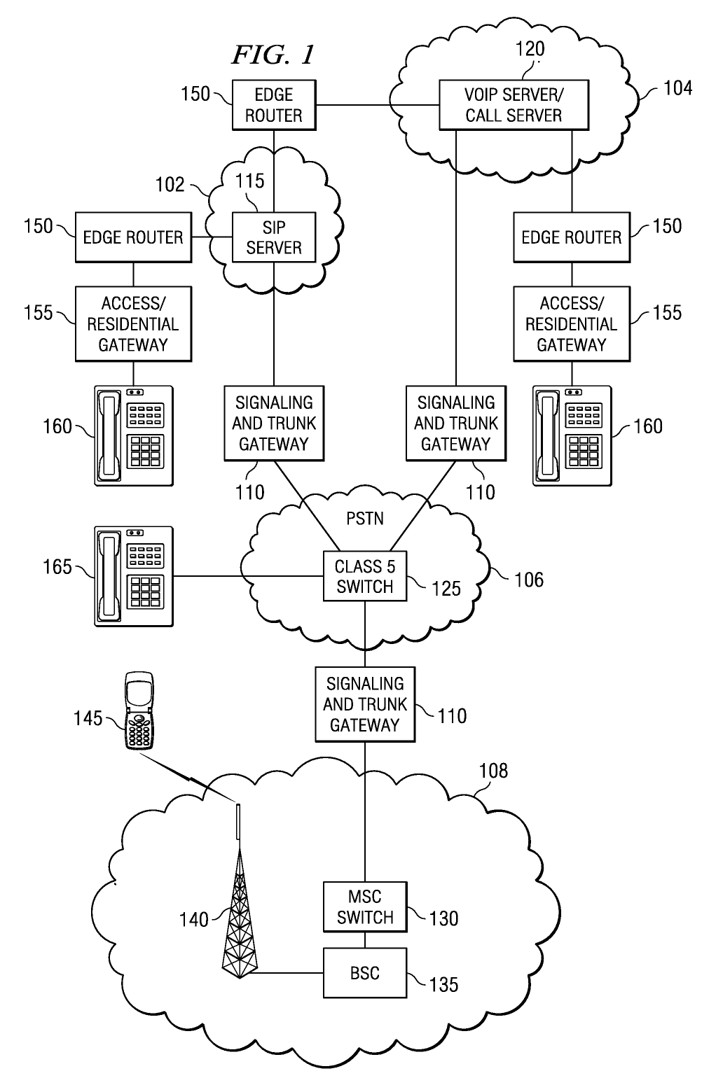

Referring to FIG. 1, an exemplary network environment including exemplary communication networks provided by service providers in which the systems, apparatus, and methods of the present invention can be implemented will be discussed. The communication networks include a first Voice over Internet Protocol (VoIP) network 102, a second VoIP network 104, a public switched telephone network (PSTN) 106, and a mobile switching network 108. The first and second VoIP networks 102, 104 and the mobile switching network 108 can be connected to the PSTN 106 by signaling and trunk gateways 110 for providing signaling translation, signaling transport conversion and transcoding.

Each of the communication networks includes a call manager for providing call logic and call control functions. However, the configuration of the call manager will depend upon the particular communication network. For example, the first VoIP network 102 can include a Session Initiation Protocol (SIP) server 115 as the call manager, the second VoIP network can include a VoIP server/call server 120 as the call manager, the PSTN 106 can include a class 5 switch 125 as the call manager, and the mobile switching network 108 can include a mobile switching center (MSC) switch 130 as the call manager.

The mobile switching network 108 includes a base station controller (BSC) 135 for controlling one or more base stations 140 to thereby provide communication services to a client (hereinafter referred to interchangeably as either client or callee) via customer premise equipment (CPE) such as an exemplary cellular telephone 145 having a wireless connection with one of the base stations 140.

Each of the first and second VoIP networks 102, 104 can include edge routers 150 for routing IP traffic onto the carrier backbone network and an access/residential gateway 155 for providing support for plain old telephone service (POTS) phones. The access/residential gateway 155 is typically controlled by the call manager of the VoIP network through a device control protocol such as H.248 (Megaco) or media gateway control protocol (MGCP) if the access/residential gateway 155 is providing an interface to a POTS telephone. The CPE 160 can receive communication service from a respective one of the first and second VoIP networks 102, 104 through the access/residential gateways 155 or directly from the edge routers 150. The CPE 160 can be a POTS telephone, IP telephone, personal computer, or the like.

A client of the PSTN 106 can receive communication services by connecting a CPE 165 to a subscriber line coupled to the class 5 switch 125 at the PSTN 106.

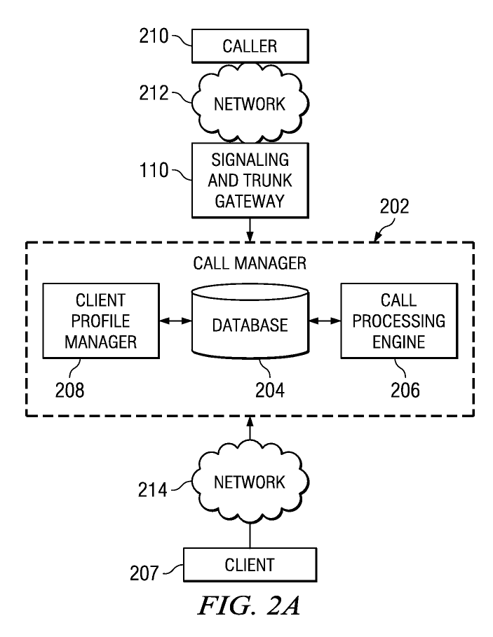

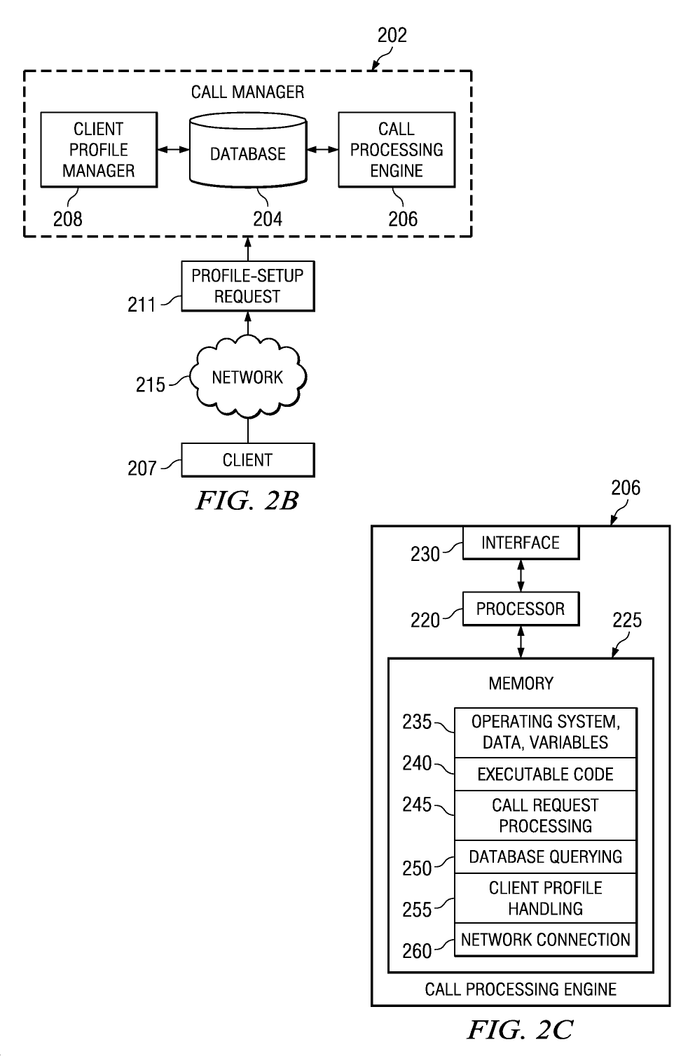

Referring to FIG. 2A, an exemplary call manager 202 that can be implemented at each of the communication networks will be discussed in more detail. The call manager 202 includes a database 204, a call processing engine 206 and a client profile manager 208.

The database 204 can be one or a combination of a variety of types of memory such as random access memory (RAM), read only memory (ROM), flash memory, dynamic RAM (DRAM) or the like. The database 204 includes client profiles for the clients of the service provider's communication network. Each of the client profiles can include identification data for the respective client (depicted generally by 207) and one or more client-defined conditions for accepting calls. The identification data for the client 207 can be, for example, a Session Initiation Protocol (SIP) Uniform Resource Locator (URL), an E.163/E.164 address (telephone number), an e-mail user identification, and/or a peer-to-peer Internet telephony network user identification. The client-defined conditions can be caller identifications from which calls are to be accepted, a general time frame in which calls are not or are accepted, or time frames for particular caller identifications in which calls are not accepted or in which calls are accepted. Other possible client-defined conditions for accepting calls include prohibiting calls from certain area codes, domains, or the like.

The call processing engine 206 is coupled to the signaling and trunk gateway 110 to receive and reply to call requests from callers (depicted generally by 210) via, for example, a network 212. The call processing engine 206 is also coupled to the database 204 in order to determine the location of the client 207 specified in the call request, and to send the call request to the determined location or forward it to another call processing engine (not shown). The call processing engine 206 can use the database 204 or a separate location service to determine the location of the client 207. Further, as discussed more fully below, the call processing engine 206 can obtain the client profile stored in the database 204 in order to provide rules-based restrictions of incoming calls. The call processing engine 206 can also be coupled to the client 207 via a network 214 for call setup. The network 214 can be an IP network, PSTN, cellular, etc.

The client profile manager 208 is for receiving client profile modification requests such as a PROFILE-SETUP request 211 from the client 207 requesting changes to the client profile, and modifying the client profile in accordance with the client profile modification request as shown in FIG. 2B. For example, the PROFILE-SETUP request 211 can include removal or addition of a call identification for which calls are not to be accepted, or the modification of time periods in which calls in general or calls from particular callers are accepted. The client 207 can send the PROFILE-SETUP request 211 to the client profile manager 208 directly or by a connection to a network 215 such as the Internet via a World Wide Web interface, or the PSTN via a Dual-tone multi-frequency (DTMF) sequence, an interactive voice response based system, via an operator or a multimedia message.

The database 204, call processing engine 206, and client profile manager 208 can be implemented by one or more processors and a memory at a single computing device or server, or can be implemented by separate computing devices or servers at separate locations coupled together via a network connection. That is, the call manager 202 can be composed of separate entities disposed at separate locations connected together via a network connection.

Referring to FIG. 2C, the call processing engine 206 will be discussed in further detail. The call processing engine 206 can include a processor 220, a memory 225 coupled to the processor 220, and an interface 230 for coupling the processor 220 to external or internal entities such as the database 204 and the signaling and trunk gateway 110. The processor 220 can be one of a variety of different processors including general purpose processors, custom processors, controllers, compact eight-bit processors or the like. The memory 225 can be one or a combination of a variety of types of memory such as RAM, ROM, flash memory, DRAM or the like.

The memory 225 includes a basic operating system, data, and variables 235 and executable code 240. The memory 225 can further include computer programs (or instructions) for configuring the processor 220 to perform the tasks required of the call processing engine 206. Particularly, the memory 225 can include: call request instructions 245 for configuring the processor 220 to process call requests for clients received from the callers; database querying instructions 250 for configuring the processor 220 to query the database 204 to obtain a client profile for a particular client in response to the call request; and client profile handling instructions 255 for configuring the processor 220 to determine if the call request from the caller satisfies the one or more client-defined conditions and reject the call request if it does not satisfy the one or more client-defined conditions.

The memory 225 can further include network connection instructions 260 for configuring the processor 220 in accordance with the type of communication network used for establishing network connections between callers and clients. For example, if the communication network is a PSTN, then the processor 220 can be configured in accordance with a class 4 or class 5 switch for establishing a PSTN connection. If the communication network is a mobile switching network, then the processor 220 can be configured in accordance with a MSC switch for establishing a cellular connection; a mobile Home Location Register (HLR) for storing details for each client; and/or a mobile Visitor Location Register (VLR) to store information about all the mobiles that are currently under the jurisdiction of the mobile switching network.

If the communication network is a VoIP network, then the processor 220 can be configured in accordance with a Session Initiation Protocol (SIP) proxy or an H.323 gatekeeper for establishing an IP network connection and providing address translation and network access control.

The processor 220 can further be configured in accordance with a Media Gateway Control Protocol (MGCP) call agent or Megaco media gateway controller for providing conversion of media signals between circuits of a PSTN and packets of a packet based network such as a VoIP network.

The client profile handling instructions 255 can further configure the processor 220 to generate multiple access numbers for the client and to associate the multiple access numbers to one or more devices to which the call is to be terminated. For example, if the communication network is a VoIP network in which the identification data for the client includes an SIP URL for the client, then the processor can generate multiple SIP URLs for the client and associate the multiple SIP URLs to one or more devices to which the call is to be terminated.

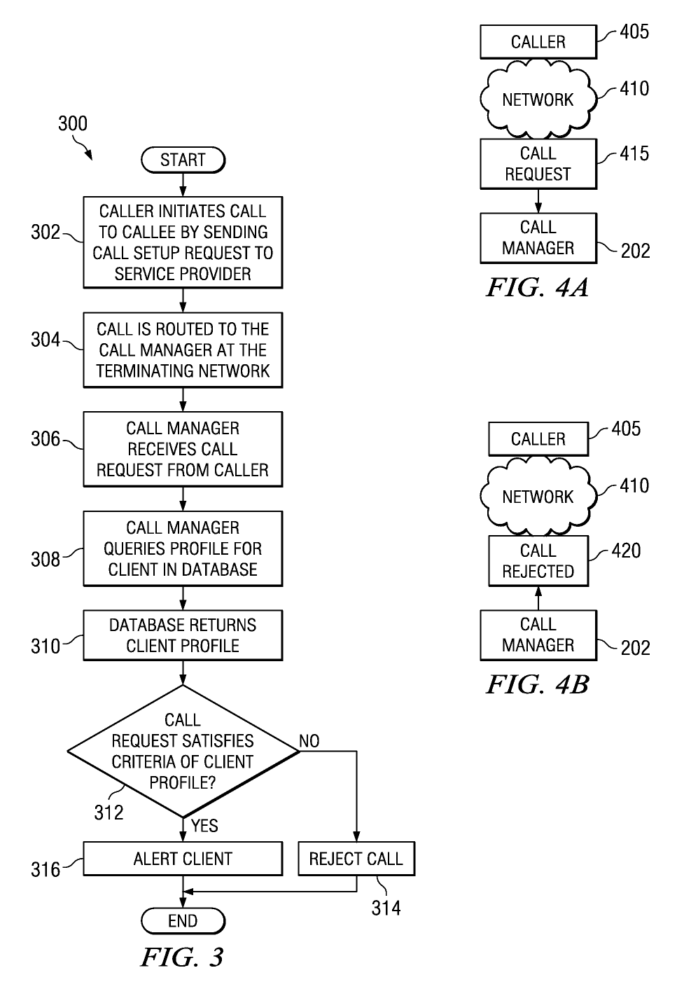

Referring to FIG. 3, an exemplary procedure 300 for providing rules-based restriction of incoming calls for a client will be discussed. At 302, a caller initiates a call to the client by sending a call setup request to the caller's service provider. The call setup request can be a setup message or an admission request (ARQ) message from the caller, an SS7 IAM message, or an INVITE request from the caller. The call request includes caller and callee (client) specific identification information such as, for example, a SIP URL, an E.163/E.164 address (telephone number), e-mail user identification, a peer-to-peer Internet telephony network user identification or the like.

At 304, the call is routed to the call manager at the terminating network, and at 306 the call manager receives the call request from the caller. At 308, the call manager queries the database to obtain the client's client profile based upon the client specific identification information in the call setup request. At 310, the database returns the client profile for the client. This scenario is shown in FIG. 4A, in which the call manager 202 receives a call setup request 415 from the caller 405 via a network 410, and queries the database for the client profile.

At 312, the call manager determines if the call request complies with client preferences, or criteria, defined in the client profile. If at 312 the call manager determines that the call request does not comply with the client preferences, then at 314 the caller is rejected, or redirected to an interactive voice response (IVR) or voice mail server and the procedure ends. This scenario is shown in FIG. 4B, in which the call manager 202 returns a call rejected message 420 to the caller 405. The call rejected message 420 can be, for example, a prerecorded error message, a busy signal, or a redirection to the voice mail server of the client depending upon the client preferences.

If, at 312, the call manager determines that the call request does comply with the client preferences of the client profile, then at 316 the call manager alerts the client by, for example, ringing the client, or, if the client's CPE is a computing device, causing a window to appear at the client's CPE, to thereby initiate an interactive data exchange session between the caller and the client and the procedure ends.

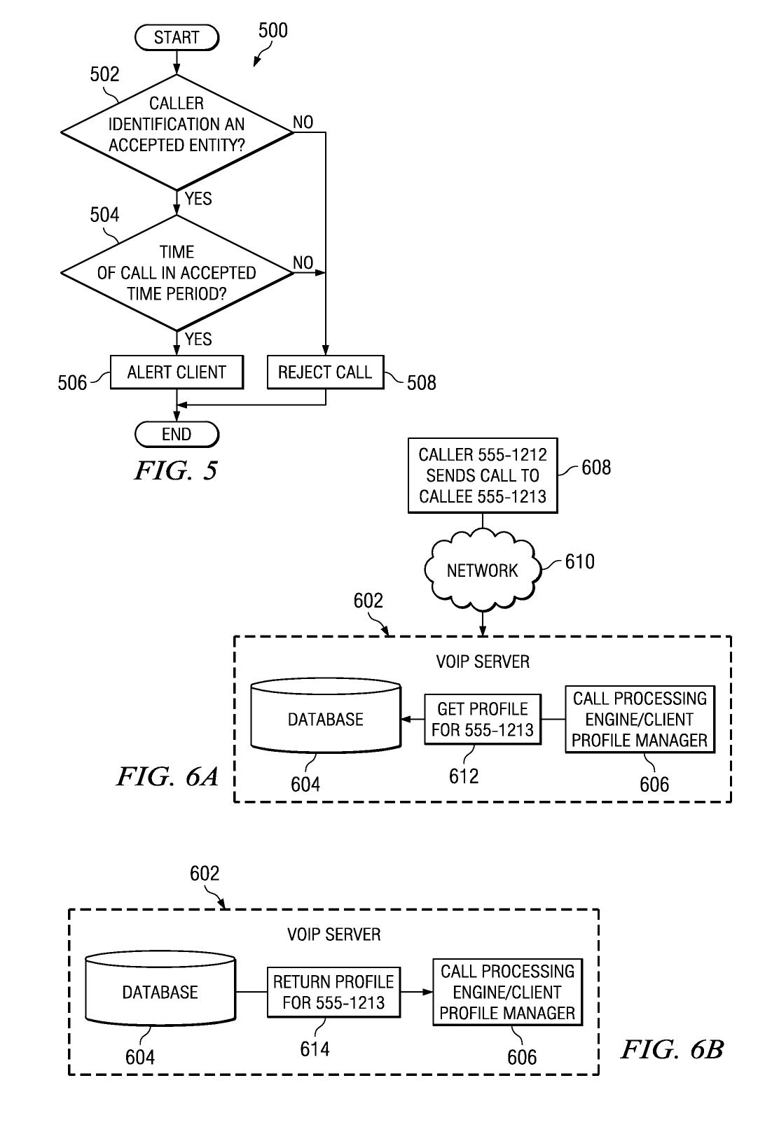

Referring to FIG. 5, an exemplary procedure 500 for determining if the call request complies with exemplary client preferences will be discussed. At 502, the call manager determines if the caller specific identification information in the call request is among one or more permissible caller identifications specified in the client profile. That is, the call manager determines if the caller is an accepted entity.

If at 502, the call manager determines that the caller specific identification information in the call request is among the permissible caller identifications, then at 504 the call manager determines if the call request was sent during a permissible time period defined in the client profile.

If at 504 the call manager determines that the call request was sent during the permissible time period, then at 506 the call manager sets up the call to the client. For example, the call manager can alert the client by ringing the client's CPE. If the client answers the CPE, then a conventional call negotiation can be performed between the client and the caller to establish a communication link.

If at 502 the call manager determines that the caller specific identification information in the call request is not among the permissible caller identifications, or if at 504 the call manager determines that the call request was not sent during the permissible time period then at 508 the call manager rejects the call.

Referring to FIGS. 6A-6B, an exemplary call manager and exemplary operations of the exemplary call manager will be discussed. As shown, the call manager is a VoIP server 602 including a database 604 and a call processing engine/client profile manager 606 coupled to the database 604. The database 604 includes client profiles for clients as discussed above.

As shown in FIG. 6A, the VoIP server 602 receives a call request 608 including caller and client specific identification information via a network 610. Here, the caller specific identification information is the telephone number 555-1212 and the client specific identification is the telephone number 555-1213. The call processing engine or the client profile manager 606 queries the database 604 for the client profile associated with the telephone number 555-1213. The query is depicted by 612.

As shown in FIG. 6B, the call processing engine or the client profile manage 606 receives the client profile from the database 604. The client profile being returned is depicted by 614. The call processing engine or the client profile manage 606 can determine if the call request 608 received from the caller complies with the call preferences in the client profile. The call processing engine 606 establishes a call between the client and the caller when the call request is determined to be in accordance with the call preferences in the client profile.

The call request 608 could be a setup message or an admission request (ARQ) message in accordance with the H.323 protocol, and the call processing engine 606 can include a processor configured in accordance with an H.323 gatekeeper to provide address translation and network access control. Further, the processor can be configured to modify the client profile in accordance with a PROFILE-SETUP request received from the client.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed.

Modifications or variations are possible in light of the above teachings. For example, the method for providing rules-based restrictions of incoming calls can be implemented at another network entity besides the call manager such as, for example, the access gateway or CPE. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A network-based call manager for providing rules-based restriction of incoming calls, the call manager receiving a call request from a caller to setup a call to a client, the call manager comprising:
a database including a client profile for the client, the client profile including identification data for the client and one or more client-defined conditions for accepting calls; and
a processor coupled to the database, the processor configured to:
query the database to obtain the client profile for the client in response to the call request received from the caller;
determine if the call request from the caller satisfies the one or more client-defined conditions; and
reject the call request if the call request is determined not to satisfy the one or more client-defined conditions.

2. The call manager of claim 1, wherein the processor is further configured to establish one of: a Voice over Internet Protocol (VoIP) network connection between the client and the caller; a Public Switched Telephone Network (PSTN) connection between the client and the caller; and a cellular connection between the client and the caller, if the call request is determined to satisfy the one or more client-defined conditions.

3. The call manager of claim 1, wherein the processor is further configured in accordance with one of a class 4 switch, a class 5 switch, a mobile switching center switch, a Session Initiation Protocol (SIP) proxy, an H.323 gatekeeper, a Media Gateway Control Protocol (MGCP) call agent, and a Megaco media gateway controller to receive the call request from the caller.

4. The call manager of claim 1, wherein the identification data for the client includes one of a Session Initiation Protocol (SIP) Uniform Resource Locator (URL), a telephone access number, an e-mail user identification, and a peer-to-peer Internet telephony network user identification.

5. The call manager of claim 1, wherein the processor is further configured to modify the client profile in accordance with a client profile modification request received from the client.

6. The call manager of claim 1, wherein the one or more client-defined conditions include one or more caller identifications from which calls are to be accepted.

7. The call manager of claim 1, wherein the client-defined conditions include one of a time frame in which calls are not accepted and a time frame in which calls are accepted.

8. The call manager of claim 1, wherein the client-defined conditions include one or more caller identifications and one or more time frames for the one or more caller identifications in which calls are not accepted or in which calls are accepted.

9. The call manager of claim 1, wherein the identification data for the client includes an access number for the client, wherein the processor is further configured to generate multiple access numbers for the client and to associate the multiple access numbers to one or more devices to which the call is to be terminated.

10. The call manager of claim 1, wherein the identification data for the client includes a Session Initiation Protocol (SIP) Uniform Resource Locator (URL) for the client, wherein the processor is further configured to generate multiple SIP URLs for the client and to associate the multiple SIP URLs to one or more devices to which the call is to be terminated.

11. The call manager of claim 1, wherein the processor is further configured in accordance with an H.323 gatekeeper to provide address translation and network access control, and the call request is a setup message or an admission request (ARQ) message.

12. The call manager of claim 1, wherein the processor is further configured in accordance with one of a mobile Home Location Register (HLR) and a mobile Visitor Location Register (VLR) to modify the client profile in accordance with a client profile modification request received from the client.

13. A method of providing rules-based restriction of incoming calls for a client receiving access to a network from a network entity, the method comprising:
receiving a call request to a client, the call request originated by a caller and including caller specific identification information;
querying a database coupled to the network entity to determine if the call request complies with client preferences defined in a client profile stored in the database; and
rejecting the call request if the call request is determined to not comply with the client preferences.

14. The method of claim 13, wherein the querying the database to determine if the call request complies with the client preferences further includes one of: determining if the caller specific identification information is among one or more permissible caller identifications specified in the client profile; and determining if the call request was sent during a permissible time period.

15. The method of claim 13, wherein the receiving the call request from the caller further comprises receiving a setup message or an admission request (ARQ) message from the caller.

16. The method of claim 13, wherein the receiving the call request from the caller further comprises receiving an INVITE request from the caller, wherein the method further comprises initiating an interactive data exchange session between the caller and the client if the caller specific identification information included in the INVITE request is determined to comply with the client preferences defined in the client profile for the client.

17. The method of claim 13, further comprising modifying the client profile in accordance with a PROFILE-SETUP request received from the client via one of a Web interface, a Dual-tone multi-frequency (DTMF) sequence, an interactive voice response based system, operator, and a multimedia message.

18. A computer readable medium containing instructions for causing a processor to perform the method of claim 13.

19. A Voice Over Internet Protocol (VoIP) server for providing rules-based restriction of incoming calls, the VoIP server comprising:
a database including a client profile for a client, the client profile including call preferences defined by the client; and
a processor coupled to the database, the processor configured to:
determine if a call request received from a caller requesting a connection with the client complies with the call preferences in the client profile for the client; and
establish a connection between the client and the caller when the call request is determined to be in accordance with the call preferences in the client profile.

20. The VoIP server of claim 19, wherein the processor is further configured to modify the client profile in accordance with a PROFILE-SETUP request received from the client.

21. The VoIP server of claim 19, wherein the processor is further configured in accordance with an H.323 gatekeeper to provide address translation and network access control, and the call request is a setup message or an admission request (ARQ) message.

22. The VoIP server of claim 19, wherein the processor is further configured in accordance with a Session Initiation Protocol (SIP) proxy server for providing call logic and call control, and the call request is an INVITE request.

23. The VoIP server of claim 19, wherein the call preferences include one or more caller identifications and a time frame for the one or more caller identifications in which calls are not accepted or in which calls are accepted, and one or more caller identifications for which calls are to be either routed to voice mail or rejected.
